(19) United States
(12) Patent Application Publication
(10) Pub. No.: US 2022/0318387 A1
(43) Pub. Date: Oct. 6, 2022

(54) Method and Computer for Learning Correspondence Between Malware and Execution Trace of the Malware

(71) Applicant: ACADEMIA SINICA, TAIPEI (TW)

(72) Inventors: Meng-Chang Chen, New Taipei City (TW); Yi-Ting Huang, New Taipei City (TW)

(21) Appl. No.: 17/709,923

(22) Filed: Mar. 31, 2022

Related U.S. Application Data
(60) Provisional application No. 63/169,414, filed on Apr. 1, 2021.

(51) Int. Cl. G06F 21/56; G06F 21/55; G06N 5/02

(52) U.S. Cl. CPC G06F 21/566; G06F 21/552; G06N 5/022; G06F 2221/033

(57) ABSTRACT

A method for learning a correspondence between malware behaviors and an execution trace of the malware, comprising: receiving an execution trace which includes one or more sequences of application programming interface (API) calls, wherein each of the API calls is corresponding to one or more resources of a computer system; processing each sequence of the API calls in a process, respectively, for generating a binding group embedding for each of the resources corresponding to the API calls in each of the process; aggregating the binding group embeddings in each of the processes; producing a malware representation according to the aggregated binding group embeddings; and classifying the malware representation corresponding to techniques implemented by the malware.

### CROSS REFERENCE TO RELATED PATENT APPLICATION

This patent application claims benefits of a U.S. provisional patent application No. 63/169,414 filed on Apr. 1, 2021.

### FIELD OF THE INVENTION

The present invention relates to computer malware, and more particularly, to machine learning to detect malwares described in a database.

### BACKGROUND OF THE INVENTION

Countering cyber threats is an essential factor to keep modern society working every day. However, malwares are involving every day, too. How to learn new evolutions of malwares reported from other people quickly and effectively is a key factor of success defense.

### SUMMARY OF THE INVENTION

An objective of the present invention is to provide a machine learning mechanism for quickly and effectively incorporating malware knowledges of public domain as open-source intelligence databases. The proposed mechanism is able to synchronize updates of OSINT database in a timely manner, knowledge collection can be an automatic and incremental process. Given these features, the Applicant believes that the provided system, or known as MAMBA, achieves the best performance of malicious behavior discovery among all the compared machine learning methods and rule-based approaches on all datasets, it also yields a highly interpretable mapping from the discovered malicious behaviors to relevant OSINT.

According to an embodiment, it provides a computer for implementing a neural network in order to detect one or more malicious behaviors according to samples of execution trace of the malicious behaviors, each of the samples of execution traces is corresponding to one process, each of the processes comprises one or more API (application programmable interface) calls, each API call has none, one or more resources, wherein the computer comprising one or more processors configured to implement following steps until trainable weights of the neural network are convergent: forward propagation steps, comprising: for each of the processes of each of the samples of execution traces, comprising: generating API call embeddings according to the API calls in instant one of the processes; deriving a hidden vector according to ordinal information of the API call embeddings for each of the API call embeddings; for each one of resource embeddings in each of the processes, wherein the resource embeddings are generated according to resources extracted from at least one source and the one or more resources in the API calls, comprising: calculating resource attention scores according to instant one of the resource embeddings and the API call embeddings; computing resource-based API call group vectors according to the resource attention scores and their corresponding hidden vectors; and generating a binding group embedding according to the resource-based API call group vectors and binding embeddings, wherein the binding embeddings are based on the resources in the API calls; calculating group attention scores corresponding to the processes of instant one of the samples of execution trace according to a self-attention mechanism of all the binding group embeddings; calculating a malware embedding according to the group attention scores and the binding group embeddings; and calculating a probability of each of the malicious behaviors according to the malware embedding; and backward propagation steps for updating the trainable weights.

Preferably, in order to utilize collective knowledge in public domain, the at least one source is an open-source intelligence database.

Preferably, in order to classify the resources used by the malwares, the resources are categorized into at least one of following types: file, library, registry, process and network.

Preferably, in order to embed the resources into the neural network, the resource embeddings are n-dimensional real-valued vectors generated, where n is a natural number. Preferably, the generation of the resource embeddings is done by applying a paragraph vector distributed memory method to the extracted resources.

Preferably, in order to embed the resources into the neural network, the binding embeddings n-dimensional real-valued vectors generated according to correlation pairs of techniques and resources denoted in a database, where n is a natural number.

Preferably, in order to preserve ordinal information, the hidden vectors are derived by a recurrent neural network.

Preferably, in order to find the connection between each pair of API calls and manipulated resource in a process, each of the resource attention scores is related to a maximum of one of normalized correlations corresponding to the resources of the API call embeddings and the resources embeddings in the instant one of the processes.

Preferably, in order to utilize collective knowledge in public domain, wherein one of the malicious behaviors is defined as one of tactics, techniques and procedures (TTPs) found in an open-source intelligence database.

Preferably, in order to inference the trained neural network, the one or more processors are further configured to execute instructions for: applying an execution trace to the trained neural network; and determining whether each of the malicious behaviors is included in the execution trace according to the probabilities corresponding to each of the malicious behaviors outputted by the trained neural network, respectively.

According to an embodiment of the present application, it provides a method for implementing a neural network in order to detect one or more malicious behaviors according to samples of execution trace of the malicious behaviors, each of the samples of execution traces is corresponding to one or more processes, each of the processes comprises one or more API (application programmable interface) calls, each API call has none, one or more resources, wherein the method comprising following steps until trainable weights of the neural network are convergent: forward propagation steps, comprising: for each of the processes of each of the samples of execution traces, comprising: generating API call embeddings according to the API calls in instant one of the processes; deriving a hidden vector according to ordinal information of the API call embeddings for each of the API call embeddings; for each one of resource embeddings in each of the processes, wherein the resource embeddings are generated according to resources extracted from at least one source and the one or more resources in the API calls, comprising: calculating resource attention scores according to instant one of the resource embeddings and the API call embeddings; computing resource-based API call group vectors according to the resource attention scores and their corresponding hidden vectors; and generating a binding group embedding according to the resource-based API call group vectors and binding embeddings, wherein the binding embeddings are based on the resources in the API calls; calculating group attention scores corresponding to the processes of instant one of the samples of execution trace according to a self-attention mechanism of all the binding group embeddings; calculating a malware embedding according to the group attention scores and the binding group embeddings; and calculating a probability of each of the malicious behaviors according to the malware embedding; and backward propagation steps for updating the trainable weights.

Preferably, the provided method is implemented by the one or more processors of the aforementioned computer with the provided features or limitations.

According to an embodiment of the present application, it provides a method for learning a correspondence between malware behaviors and an execution trace of the malware, comprising: receiving an execution trace which includes one or more sequences of application programming interface (API) calls, wherein each of the API calls is corresponding to one or more resources of a computer system; processing each sequence of the API calls in a process, respectively, for generating a binding group embedding for each of the resources corresponding to the API calls in each of the process; aggregating the binding group embeddings in each of the processes; producing a malware representation according to the aggregated binding group embeddings; and classifying the malware representation corresponding to one or more techniques implemented by the malware.

Preferably, in order to correlate resources used in the API calls in a sequence, the binding group embedding for one of the resources is generated according to a group embedding and a binding embedding corresponding to the one of the resources.

Preferably, in order to take advantage of knowledge regarding to connections of techniques and resource denoted in a database, the binding embedding corresponding to the one of the resources is derived from a resource-technique neural network which is trained according to correlation pairs of techniques and resources denoted in a database.

Preferably, in order to concern about the connections between an API call and its corresponding resources, the group vector corresponding to the one of the resources is a weighted average of hidden states of the resources corresponding to the API call.

Preferably, weights of the weighted average of hidden states are resource attention weights of the one of the resources in a process and the resources corresponding to the API call.

Preferably, the resource attention weights are normalized according to a distribution of the resources corresponding to the API call.

Preferably, in order to preserve ordinal information of API calls in a process, the hidden states of the resources corresponding to the API call are provided by a recurrent neural network which operates on API embeddings corresponding to the API calls of the execution trace.

Preferably, in order to utilize API call information in the neural network, each of the API embeddings is a concatenation of an embedding of a category, an embedding of an API name, and one or more resource embeddings corresponding to the resources corresponding to the API call.

Preferably, the resource embeddings are transformed by a paragraph vector distributed method.

Preferably, in order to provide correlation likelihood of resources and techniques learned from the database (as binding embedding), the resource-technique neural network is a multiple layered perceptron (MLP) network.

Preferably, each of the correlation pairs includes resource embeddings of the resources denoted in the database, wherein the resource embeddings are transformed by a paragraph vector distributed method.

Preferably, the malware representation is produced further according to group attentions scores of the binding group embeddings in each of the processes.

Preferably, in order to provide independent classification in a multi-label problem of techniques, the classifying uses a sigmoid function of the malware representation.

Preferably, in order to adapt knowledge of public domain, the database is according to MITRE ATT&CK framework.

According to an embodiment of the present application, it provides a computer for learning a correspondence between malware behaviors and an execution trace of the malware, comprising: a non-volatile memory for storing instructions and data corresponding to the instructions; and a processor configured to execute the instructions for: receiving an execution trace which includes one or more sequences of application programming interface (API) calls, wherein each of the API calls is corresponding to one or more resources of a computer system; processing each sequence of the API calls in a process, respectively, for generating a binding group embedding for each of the resources corresponding to the API calls in each of the process; aggregating the binding group embeddings in each of the processes; producing a malware representation according to the aggregated binding group embeddings; and classifying the malware representation corresponding to one or more techniques implemented by the malware.

Preferably, what the processor executes is met with the aforementioned features and limitations corresponding to the method.

### BRIEF DESCRIPTION OF THE DRAWINGS

The advantages and spirit related to the present invention can be further understood via the following detailed description and drawings.

FIG. 1 illustrates mapping knowledge from MITRE ATT&CK to a malware trace. The top MITRE webpage is about sub-technique T1547.001 and the bottom shows the API calls of JCry to partially carry out the technique.

FIG. 2 depicts life cycle of a malware sample from a malware family JCry.

FIG. 3 shows general relationships of terms defined in a general model provided by the OSINTs.

FIG. 4 illustrates a flowchart diagram in accordance with an embodiment (MAMBA) of the present application.

FIG. 5 depicts a neural network model described in the Algorithm 1 in accordance with an embodiment (MAMBA) of the present application.

FIG. 6 depicts comparisons of MAMBA and security vendors on 56 TTPs listed in APT29 Evaluation.

FIG. 7 depicts a group attention and resource attention diagram in JCry analysis in accordance with an embodiment of the present application.

FIG. 8 shows TABLE 1 “Regular Expressions for Resource Categories” in accordance with an embodiment of the present application.

FIG. 9 shows TABLE 2 “Dataset Statistics”.

FIG. 10 shows TABLE 3 “Comparisons of ATT&CK Dataset”.

FIG. 11 shows TABLE 4 “Comparisons of Big Dataset”.

FIG. 12 shows TABLE 5 “Ablation Test Results on Big Dataset”.

FIG. 13 shows TABLE 6 “The Discovered Life Cycle of JCry”.

FIG. 14 shows TABLE SI “The API Calls Related to Discover TTPs are used” in the present application.

FIG. 15 depicts a computer 1500 in accordance with an embodiment of the present application.

FIG. 16 depicts a method 1600 in accordance with an embodiment of the present application.

### DETAILED DESCRIPTION OF THE PREFERRED EMBODIMENT

Some embodiments of the present application are described in details below. However, in addition to the description given below, the present invention can be applicable to other embodiments, and the scope of the present invention is not limited by such rather by the scope of the claims. Moreover, for better understanding and clarity of the description, some components in the drawings may not necessary be drawn to scale, in which some may be exaggerated related to others, and irrelevant. If no relation of two steps is described, their execution order is not bound by the sequence as shown in the flowchart diagram.

Cyber threats are one of the most pressing issues in the digital age. There has been a consensus on deploying a proactive defense to effectively detect and respond to adversary threats. The key to success is understanding the characteristics of malware, including their activities and manipulated resources on the target machines. Open-source intelligence (OSINT) such as the popular MITRE ATT&CK framework (ATT&CK) provides rich information and knowledge about adversary lifecycles and attack behaviors. The main goals of this present application involve knowledge collection from OSINT (e.g. ATT&CK), malicious behavior identification using deep learning, and the identification of associated API calls. MAMBA, a system provided by the present application for malware, incorporates OSINT (e.g. ATT&CK) knowledge and considers attentions on manipulated resources and malicious activities in the neural network model. To synchronize OSINT as well as ATT&CK updates in a timely manner, knowledge collection can be an automatic and incremental process. Given these features, the Applicant believes that the provided system, MAMBA, achieves the best performance of malicious behavior discovery among all the compared machine learning methods and rule-based approaches on all datasets, it also yields a highly interpretable mapping from the discovered malicious behaviors to relevant OSINT.

Cyber-attacks have proliferated recently, incurring damages that cost individuals and companies dearly. A powerful proactive defense collects information about known attacks and comprehensively understands malicious behaviors, and further exploits this knowledge to interdict and disrupt attacks or preparations for attack [1], [2]. Thus, it is crucial to grasp the characteristics of malicious behavior and the resources used therein. Open-source intelligence (OSINT) assimilates experience and knowledge from the cybersecurity community to form a common knowledge base for cyber threat studies that best supports a proactive defense.

The attack development life cycle, such as Lockheed Martin's cyber kill chain [3], the MITRE ATT&CK (Adversarial Tactics, Techniques and Common Knowledge) framework (hereafter referred to as ATT&CK) [4], and Mandiant's adversary life cycle [5], describes the adversary process at each stage of the attack. Take for example ATT&CK: the framework is designed to describe the attacker intent and malicious behavior at each tactic stage. Once all malicious behaviors are compiled, the cybersecurity analyst can correlate them to derive a clear picture of the attack and take the necessary action to stop or mitigate the attack. The strength of ATT&CK, one of most popular OSINTs, is its structure and openness in collecting and sharing cyber threat intelligence. In an embodiment of this present application, the contents of ATT&CK are considered as examples to build the needed knowledge about malware behavior to facilitate dynamic malware analysis via deep learning.

Information about adversaries is commonly published in cyber threat intelligence (CTI) reports presented with semantic descriptions and lists of manipulated resources. Comprehension of CTI is a large-scale data-driven process that involves systematic analysis of observations, including malware, suspicious events, and other rapidly evolving cybersecurity data. To facilitate the CTI usage, many studies [6], [7], [8], [9], [10] focus on collecting, analyzing, and extracting evidence such as indicators of compromise (IoCs) in CTI reports. Dealing with increasingly sophisticated cyber threats and obtaining an overall picture of the fast-evolving attack scenario from OSINT CTI helps cybersecurity analysts handle potential attacks as they are unveiled.

Holmes [11] and RapSheet [12] are state-of-the-art systems that use system logs to build a provenance graph and apply manually crafted expert rules to discover advanced persistent threats or tactics, techniques, and procedures (TTPs) to detect potential attacks on their host systems. In some embodiments of this present application, in contrast to investigating a computer's system log, the implementations rely on analyzing the dynamic behavior of malware using the knowledge from OSINT (e.g., ATT&CK) and neural networks.

To analyze malware activities, dynamic analysis tools such as Cuckoo Sandbox [13], CWSandbox [14], and APIf [15] can record execution traces. Cuckoo Sandbox further applies ATT&CK with rules contributed by volunteers to detect malicious behavior. However, due to the crowd-sourced nature of Cuckoo Sandbox, the completeness and timeliness of the contributed rules (called Cuckoo Signatures) may not be consistent with ATT&CK. Therefore, in this present application, regular expression rules are constructed to implement the knowledge within ATT&CK to be used as a labeling method, in addition to the Cuckoo Signatures, for later use in deep learning. OSINT information such as the MITRE website is extracted and the relations of TTPs and malware are organized such that they can be used as another labeling method. To account for OSINT database (e.g., the MITRE website) updates, all the labeling processes may be automatic and incremental.

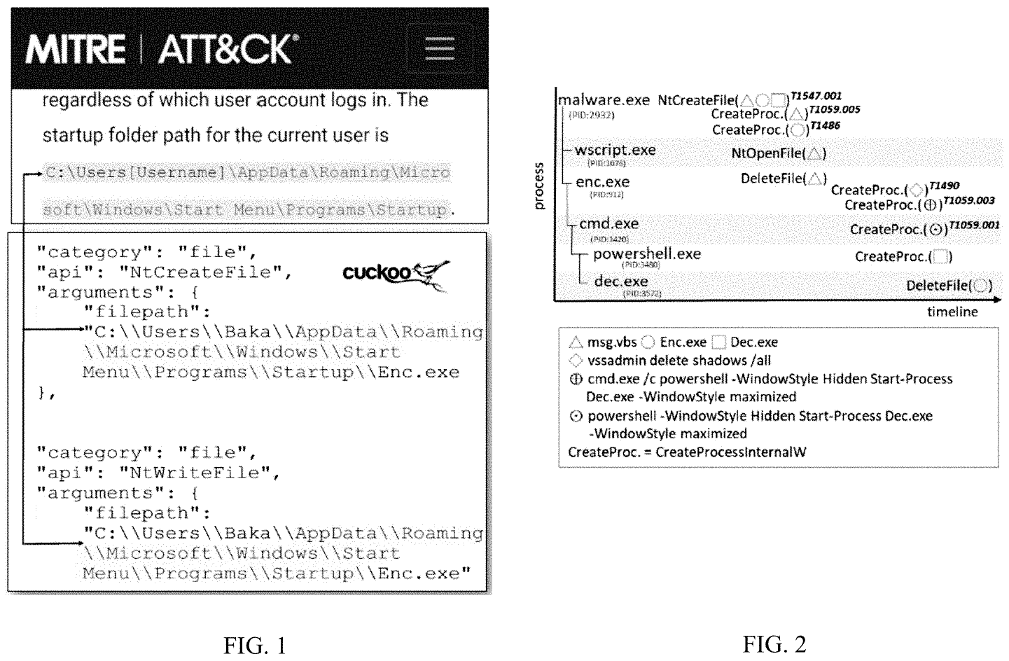

For dynamic malware analysis, we provide a neural network model to scan execution traces to identify potentially malicious activities with execution codes (i.e., API calls) corresponding to ATT&CK TTPs. In FIG. 1, the sub-technique T1547.001 Bool or Logon Autostart Execution: Registry Run Keys/Startup Folder refers to adding an executable program to a startup folder to maintain a foothold. This sub-technique can be identified when a malware sample attempts to add a malicious payload to the startup folder. High-level descriptions of TTPs in ATT&CK serve as interpretations of malicious behavior, and they can be used to link to low-level execution traces of malware by the proposed neural network.

The goal of this present application is to integrate OSINT (e.g. ATT&CK) with a neural network model to analyze an execution trace of malware, and discover the malicious behaviors, and describe them as a collection of TTPs and their associated API calls to host operating systems. In general, the present application involves and conquer several challenges:

Knowledge collection. The first step is to gather the manipulated resources associated with TTPs embedded in the OSINT (e.g., MITRE) as knowledge; the essential knowledge about the collected resources as well as inevitably some noisy information is exploited.

TTP identification. the knowledge acquired from the OSINT (e.g., ATT&CK) is combined into the proposed neural network to identify TTPs from a malware sample's execution trace.

API call locating. Aligning high-level TTPs to a low-level execution trace is a challenge that helps cybersecurity analysts to comprehend malicious behavior.

In one embodiment, we present MAMBA (MITRE ATT&CK based malicious behavior analysis), a system that addresses the above aspects. MAMBA starts by extracting the TTPs and their corresponding resources to compile knowledge from the MITRE website and cited references, and it discovers TTPs from malware and their corresponding API execution call sequences. MAMBA makes novel use of the information presented in ATT&CK as the pivotal reference in addressing the above three challenges in malware behavior interpretation. To summarize, the present application offers the following contributions:

MAMBA incorporates knowledge from ATT&CK in deep learning analysis to discover malicious behavior.

The MAMBA design and methodology are examined extensively using the contents of MITRE as well as real-world data. The evaluation outcomes meet the three challenges.

The present application shows that the open-source intelligence such as the MITRE ATT&CK framework facilitates cybersecurity applications.

In following section, we introduce a motivating example and present insight into using ATT&CK to interpret the malicious behavior lifecycle from an execution trace.

With regard to the motivating example, we analyze a malware sample (MD5 c86c75804435efc380d7fc436e344898) classified as a member of the JCry family [16], [17]. FIG. 2 depicts the JCry life cycle with an emphasis on its created processes, discovered TTPs, and the manipulated resources. JCry is ransomware disguised as an Adobe flash player update installer. Once it is clicked, it creates malicious files msg.vbs (Δ), Enc.exe (∘), and Dec.exe (□), and stores these malicious files in the startup folder to maintain its persistence (in ATT&CK this is identified as T1547.001 Boot or Logon Autostart Execution: Registry Run Keys/Startup Folder). These programs are executed when the user logs in. Executing msg.vbs displays an “Access Denied” message to warn that the Adobe Flash Player failed to update (T1059.005 Command and Scripting Interpreter: Visual Basic). The executable file Enc.exe encrypts the user's files for ransom (T1486 Data Encrypted for Impact), and also deletes shadow copies using a command to prevent recovery (T1490 Inhibit System Recovery), after which it launches Dec.exe using PowerShell to display the ransom note (T1059.003 Command and Scripting Interpreter: Windows Command Shell, T1059.001 Command and Scripting Interpreter: PowerShell).

We offer two observations. First, the manipulated resources are useful to group processes and API calls which work together to carry out malicious activities. For example, the manipulated resource Enc. exe is used by the “malware.exe (PID=2932)”, “enc.exe (PID=912)”, and “dec.exe (PID=3572)” processes for its creation, execution, and deletion. Second, the malicious activities associated with these manipulated resources, e.g., files and commands, may correspond to techniques in ATT&CK. For example, the command, “cmd.exe/c powershell-WindowStyle Hidden StartProcess Dec.exe-WindowStyle maximized” can be found on the ATT&CK TTP webpages (T1059.001 and T1059.003). While such malicious behavior is traditionally represented by indicators of compromise (IoCs) or signatures in intrusion detection systems (IDSs), in OSINT databases such as ATT&CK they are presented using natural language descriptions. In this present application; the abundance and openness of OSINT databases such as the ATT&CK information facilitates the use of information retrieval techniques to collect and convert this data into knowledge for later use.

Based on observations from the motivating example, the design criteria of the provided system or MAMBA include the following.

Explainable. Different from traditional malware detection or malware classification, we discover high-level TTPs associated with low-level API calls when given a malware sample.

Comprehensive. Malicious behavior may consist of a series of operations. By considering resource dependencies, the provided system finds related TTPs and the associated resources and API calls.

Extendable. Since cyber threats are constantly evolving, knowledge in OSINT databases such as ATT&CK continues to accumulate. Our model adapts to new adversarial TTPs in OSINT databases, e.g., ATT&CK.

As a populous and famous OSINT database or framework, ATT&CK is a document source of post-compromise adversarial tactics and techniques based on real-world observations. From the contents of [4], ATT&CK is a behavioral model that consists of adversary tactics, techniques, and procedures (TTPs). Some common terms used in OSINT databases or frameworks are explained below:

Tactic. A tactic represents the goals of an adversary. It categorizes the attack life cycle into different stages.

Technique. A technique/sub-technique represents the technical means through which goals are accomplished. A sub-technique, inheriting a technique, corresponds to more specific action.

Procedure. A procedure in ATT&CK is exemplified by real-world examples, either software or an adversary group, to show their use of techniques or sub-techniques.

Adversary group. An adversary group is tracked by a common name in threat intelligence reports. They use software and techniques to achieve their tactical objectives.

These relationships can be visualized in FIG. 3. Each tactic serves as a class of techniques implemented by software to accomplish the tactic. For example, to establish persistence (tactic), JCry (malware) may add a downloaded payload to the startup folder (sub-technique T1547.001). Currently, there is no tie between JCry and any particular adversary group.

In recent years, this framework has become popular for describing the attack life cycle of either malware or an adversary group. In some embodiments of the present application, the techniques of all stages of Windows malware samples from ATT&CK are discussed. In this present application, techniques refer to techniques as well as sub-techniques (hereafter techniques) and resources refer to files, libraries (modules), registries, processes, and networks. Malicious behavior of a malware sample can be represented by one or more techniques; the attack life cycle (kill chain) of malware is composed of a series of techniques.

OSINT databases or frameworks such as the MITRE website provide descriptions of techniques for which MAMBA, the provided system extracts resources and matches them with arguments of the API calls. This strategy is also supported by [18], in which a comprehensive analysis demonstrates a strong correlation between ATT&CK techniques and Windows API calls. As shown in FIG. 1, the resource mentioned in the webpage for technique T1547.001 Registry Run Keys/Startup Folder indicates that T1547.001 may be discovered if resource “C:\\Users\\ . . . \\Startup\\Enc.exe” is accessed in an execution trace. As the figure shows, the specific resource can be found in the both API calls “NtCreateFile” and “NtWriteFile” that the connection constitutes an important clue to understanding the malicious activity. Following this procedure, a neural network model of the provided system or MAMBA is designed to learn the associations between TTPs and execution traces.

The main design goal of the provided system or MAMBA is to align a resource annotated with a TTP in ATT&CK to a manipulated resource used by malware. In this the present application, matrices are represented using uppercase characters and vectors are represented in boldface using lowercase characters.

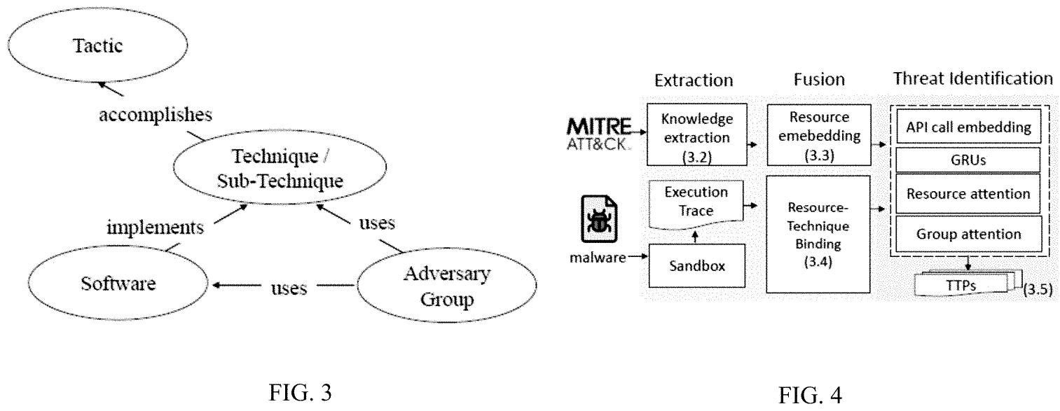

A high-level overview of the provided system or MAMBA workflow is shown in FIG. 4: this is composed of an extraction phase, a fusion phase, and a threat identification phase. The extraction phase includes technique extraction by extracting knowledge tuples from the OSINT database or framework such as ATT&CK, and malware execution trace generation from a sandbox. The technique pages in the OSINT database or framework such as ATT&CK present use cases performing the corresponding techniques. These use cases are treated as observable clues by which to detect techniques and are extracted by the provided system or MAMBA as the technique knowledge. We also consider series of API calls and sets of manipulated resources from an execution trace as a sequence of operations executed by malware. Both technique-related knowledge, and execution-trace API calls and resources are collected in the extraction phase.

The fusion phase involves resource embedding and resource-technique binding. Although the collected knowledge from the OSINT database or framework such as ATT&CK and execution traces indicates the same malicious behavior, their constitutions may be different. The designed embedding mechanism maps resources to fixed-size vectors while preserving their semantic properties. In addition, in resource-technique binding we use a neural network to learn the connection between resources and techniques from the OSINT database or framework such as ATT&CK, so to enable the proposed neural network to associate the embedding of resources from traces to techniques from ATT&CK.

Once the extraction phase and the fusion phase are complete, threats are identified by detecting techniques from a malware sample. First, API call embeddings are generated from the output of the fusion phase and are processed by gated recurrent units (GRUs) to obtain a sequential hidden vector. Attention mechanisms are applied to highlight the relevance between resources and API calls as well as dependencies among the bindings and API calls. Finally, threat identification yields the compromised techniques.

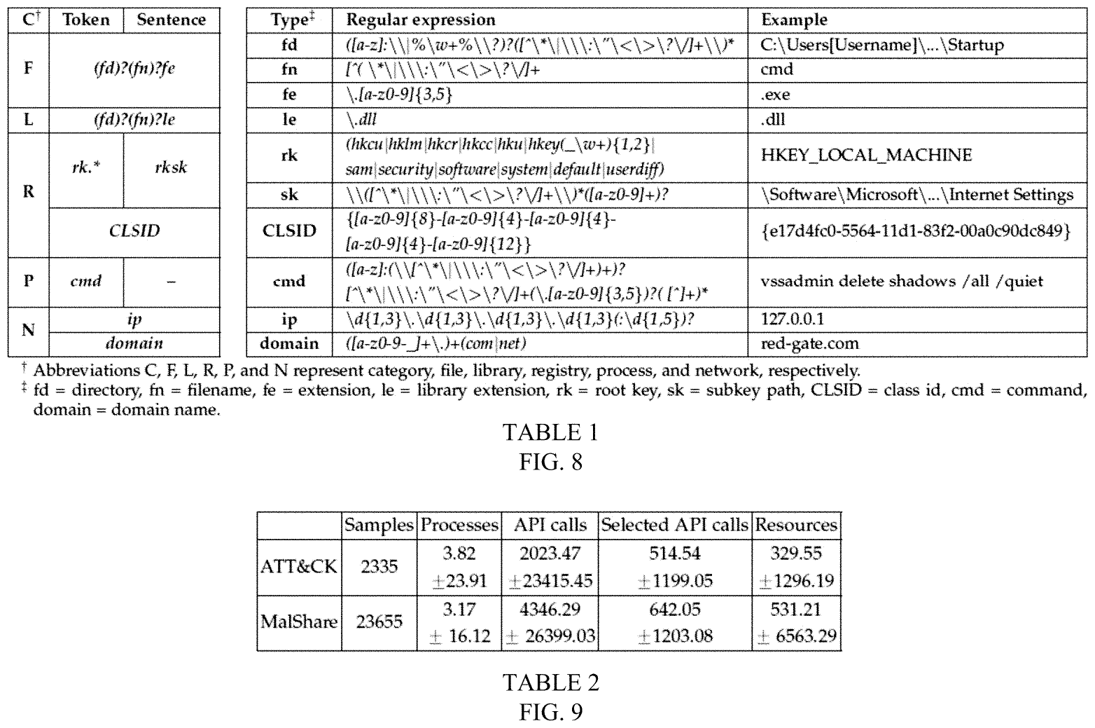

Knowledge Extraction from the OSINT database or framework such as MITRE ATT&CK Framework. The first step of knowledge extraction is to extract a disclosed resource r related to a technique y as a tuple {r, y} from the webpage for every technique in the OSINT database or framework such as MITRE ATT&CK framework. The regular expressions for r extraction from a shadowed token (a token with gray background) or a sentence in the MITRE website are expressed in Table 1 as shown in FIG. 8. A shadowed token is a complete path of resource or command line; for example, the filename “C:\\Users[Username]\\ . . . \\Startup” in FIG. 1 is a shadow token, which can be recognized as the regular expression for directory (fd). Some resources shown in a sentence require the context of the sentence to determine the boundaries. For example, the sentence “ . . . usage of the Windows Script Host (typically cscript.exe or wscript.exe) . . . ” from the MITRE webpage of T1059.005 Command and Scripting Interpreter: Visual Basic consists of two non-shadowed resources “cscript.exe” and “wscript.exe”, which can be recognized by the composition of the regular expressions for filename (fn) and extension (fe). In summary, 988 resources associated with 229 techniques, forming 2100 {r, y} pairs, from the MITRE website are collected.

In this step with regard to resource representation, each resource found from the OSINT database or framework such as ATT&CK and the execution trace is embedded into a resource embedding eᵣ. An embedding maps a variable-length resource to a fixed-length feature vector in the embedding domain. As resources are not necessarily represented in the same way between OSINT database or framework such as ATT&CK and the execution traces, we seek to preserve their closeness in the embedding domain for later neural network processing. For instance, as shown in the example in FIG. 1, the startup folder path in ATT&CK consists of the token “Users[Username]” that is slightly different from “Users\\Baka” in the execution trace. In order to facilitate the function of neural network, their embedding should be close.

In some embodiments, the paragraph vector distributed memory method (PV-DM) [19] is employed to transform a resource into an n-dimensional real-valued vector. PV-DM is an unsupervised learning algorithm to transform a sentence, a paragraph, or a document into a fixed-length vector. As it is based on skip-gram embedding techniques, it preserves semantics and word ordering to facilitate the use of embeddings for similarity computation while maintaining the closeness property. In this present application, we tokenize each resource and treat each token as a word in the PV-DM model. To reduce the influence of unseen words, we build a resource vocabulary set by excluding out-of-vocabulary and rare words whose frequency is lower than a given threshold. Once the learning of the PV-DM for resource is completed, the resource embedding function is ready.

Once resource embedding eᵣ is generated, the next step is to build a neural network to learn the relation between a resource and a technique. A resource can be seen as a plausible clue to the implementation of a technique y to achieve its tactical intent. A multiple layer perceptron (MLP) is trained using the pairs {eᵣ, y} from the OSINT database or framework such as ATT&CK, used to predict the likelihood of techniques given a resource from an execution trace.

Formally, when given a set of N pairs of {eᵣ, y} from the OSINT database or framework such as ATT&CK, the objective of learning function is to maximize the average log probability with respect to the MLP weights W_{z}:

$$max \frac{1}{N} \sum log p ( y \vert {e}_{r} , {W}_{z} ) \qquad ( 1 )$$

We apply W_{z} to derive the hidden vector zᵣ for each resource r is computed as

zᵣ=σ(W_{z}eᵣ) (2)

where σ is the activation function. For a manipulated resource extracted from an API call, we use the same embedding function to transform r into eᵣ and further compute the hidden vector z in (2) which can be considered as its contribution to TTPs.

The goal of the threat identification phase is to identify malicious behaviors (TTPs) y from a malware execution trace with API calls x={x₁, x₂, . . . , x_{p×|T|}}. Formally, when given a training set of M pairs of {x, y}, the objective of learning function is to maximize the average log probability with respect to MAMBA neural network with all trainable weights θ including W_{c}, Wₙ, Wᵥ, and W_{d} (which will be defined later):

$$max \frac{1}{M} \sum log p ( y \vert x , θ ) \qquad ( 3 )$$

The attack life cycle can be recognized by a series of techniques identified from API calls with their arguments.

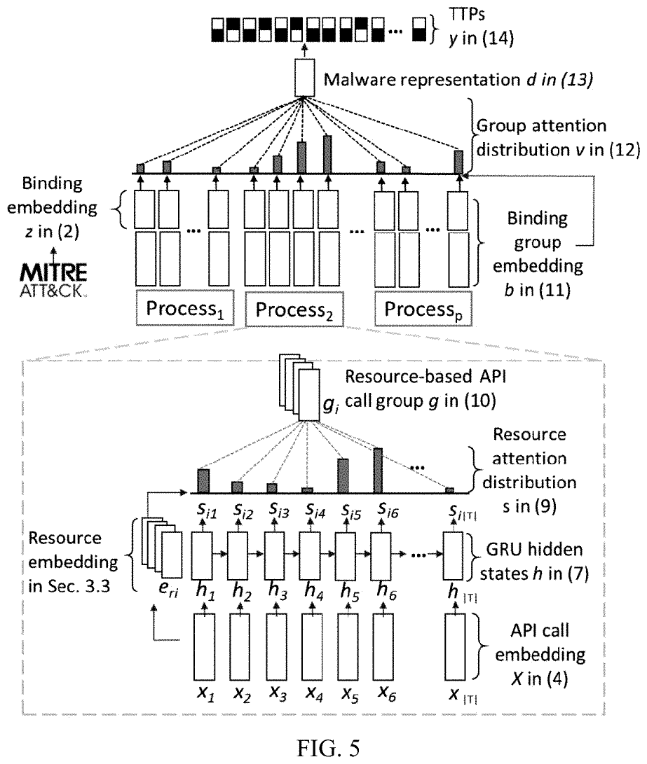

A resource-based API call group is defined as a collection of the related API calls that share the same resource. Given a malware execution trace, the threat identification phase produces resource-based API call groups for each process, after which it compares resource-based API call groups with other call groups in all processes and predicts the possible techniques. The structure of the threat identification phase is shown in FIG. 5.

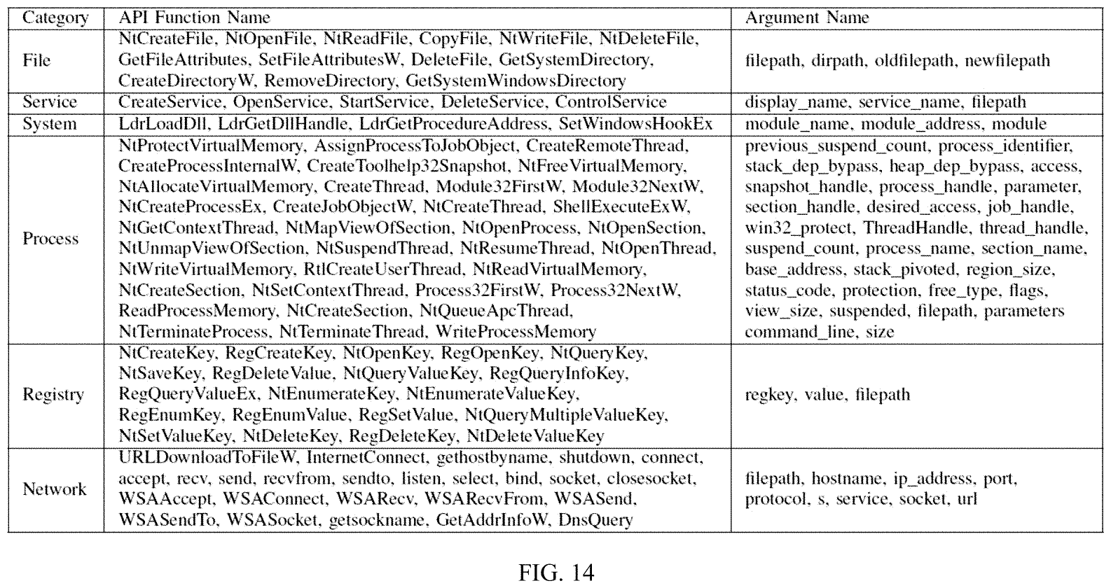

An execution trace is composed of the traces of all processes; each process trace is a sequence of API calls. A single API call x consists of a category c, an API function name n, and one or more argument values (i.e. resources). In FIG. 1, for instance, API call “NtCreateFile” belongs to the “file” category and has argument values such as “C:\\Users\\ . . . \\Startup\\Enc.exe”. The Windows API calls and categories highly related to TTPs are listed in Table SI of Supplementary Material A as shown in FIG. 14. The embedding of API call eₓ is a concatenation of embeddings of category e_{c}, API name eₙ and resources eᵣ₁, eᵣ₂, eᵣ₃ (only three resources are considered):

eₓ=[e_{c};eₙ;[eᵣ₁,eᵣ₂,eᵣ₃]] (4)

where [;] is concatenation, and eᵣ₁, eᵣ₂, eᵣ₃ are from the PV-DM model is aforementioned.

e_{c}=W_{c}x_{c} (5)

eₙ=Wₙxₙ (6)

where W_{c} and Wₙ are the weight matrices of category c and API name n, and x_{c} and xₙ are one-hot encodings of category and API name. W_{c} and Wₙ are trained during the training phase of the MAMBA neural network model.

To preserve ordinal information, the sequence of the API call embeddings in a process is handled using gated recurrent units (GRUs). Part of the recurrent neural network family, the GRU operates on a variable-length input sequence eₓ={eₓ₁, eₓ₂, . . . , e_{x|T|}} and produces a hidden state h. At time step t, the hidden state hₜ of the GRU is updated by

hₜ=GRU(hₜ₋₁,eₓ_{ₜ}) (7)

GRU learn a probability distribution over an input-sequence such that the output h encodes sequential information from the first API call to the current API call.

To find the connection between each pair of API call xₜ and manipulated resource rᵢ in a process, we use a resource attention mechanism as the score function that is the maximum value of the inner product of resource embedding eᵣ_{ᵢ} against the three resource embeddings e_{r, t} of API call xₜ in (8):

$$score ( {e}_{{r}_{i}} , {x}_{t} ) = max ( \frac{{e}_{{r}_{i}} {e}_{{r}_{1} t}}{\vert {e}_{{r}_{i}} \vert \vert {e}_{{r}_{1} t} \vert} , \frac{{e}_{{r}_{i}} {e}_{{r}_{2} t}}{\vert {e}_{{r}_{i}} \vert \vert {e}_{{r}_{2} t} \vert} , \frac{{e}_{{r}_{i}} {e}_{{r}_{3} t}}{\vert {e}_{{r}_{i}} \vert \vert {e}_{{r}_{3} t} \vert} ) \qquad ( 8 )$$

The result is normalized to derive the resource attention weight sᵢₜ as a distribution over all API calls:

$${s}_{i t} = \frac{exp ( score ( {e}_{{r}_{i}} , {x}_{t} ) )}{{\sum }_{t ′ = 1}^{\vert T \vert} exp ( score ( {e}_{{r}_{i}} , {x}_{t ′} ) )} \qquad ( 9 )$$

Given the attention weights, we compute a group vector gᵢ as the weighted API call hidden states h for a certain resource rᵢ:

gᵢ=Σₜ₌₁^{|T|}sᵢₜhₜ (10)

Also, a binding embedding zᵢ for a resource rᵢ can be acquired in (2) as a feature corresponding to technique y. The group vector gᵢ is combined with the binding embedding zᵢ to yield the binding group embedding bᵢ for each resource:

bᵢ=[gᵢ;zᵢ] (11)

For each process, the binding group embedding b includes information not only from API calls but also from the OSINT database or framework such as ATT&CK. At this step, each process is represented by a collection of binding group embeddings.

The next step is to aggregate the binding group embeddings from each process and produce a malware representation d for prediction. As shown in the example in FIG. 2, resources may be manipulated among processes; thus we apply a self-attention mechanism to highlight dependencies among the binding group embeddings. The self-attention mechanism allows each binding group embedding to interact with the other embeddings to determine which should get more attention:

vᵢ=softmax(Wᵥbᵢ) (12)

where Wᵥ is weight matrix of the two-layer dense network. The malware representation d is the aggregation of the group attention score v and the binding group embeddings b:

d=vb (13)

The technique prediction task is a multi-label classification problem with a sigmoid layer at the end of the classifier. The predicted probability of each technique produced by the sigmoid function is independent of the others:

y=sigmoid(W_{d}d) (14)

Algorithm 1 concludes the operations of so-called MAMBA neural network model or a neural network model in accordance with an embodiment provided by the present application described above.

Input: an execution trace x
Output: a set of TTPs y

| | |
|---|---|
| 01: | while all trainable weights θnot convergences do |
| 02: | Forward Propagation: |
| 03: | for each process p do |
| 04: | extracting a set of resource r from xₚ |
| 05: | getting resource embedding eᵣ according resources found in |
| | OSINT |
| 06: | getting binding embedding zᵣ in (2) |
| 07: | getting API_call_embedding(x) eₓ in (4) |
| 08: | getting hidden states h of a Recurrent Neural Network (eₓ) in |
| | (7) |
| 09: | for each resource embedding eᵣ in eᵣ do |
| 10: | getting resource_attention(eᵣ, h) sᵢₜ in (9) |
| 11: | getting group_embedding(resource_attention, h) gᵣ in (10) |
| 12: | getting binding_group(gᵣ, zᵣ) bᵣ in (11) |
| 13: | end for |
| 14: | end for |
| 15: | getting group attention(b) v in (12) |
| 16: | getting malware_representation(v, b) d in (13) |
| 17: | getting sigmoid(d) y in (14) |
| 18: | Backward Propagation: |
| 19: | conducting backward propagation with Adam; |
| 20: | end while |
| 21: | #Use the trained network to discover TTPs y of an execution |
| | trace x |

We designed experiments to answer the following critical questions.

Q1: How effectively the OSINT database or framework such as MITRE knowledge improve TTPs extraction?

Q2: How effectively are the true TTPs extracted from a given malware sample using MAMBA?

Q3: What makes MAMBA capable of identifying TTPs?

Q4: How well does MAMBA perform against realistic attack campaigns?

Q5: How well does MAMBA locate API calls associated with the predicted TTPs?

For Q1 and Q2, we collected two datasets from MITRE and MalShare [20] and used three labeling methods: MITRE, Cuckoo, and RegExp. Then we compared the performance of MAMBA, two rule-based methods, and five traditional machine learning methods. To answer Q3 and understand the contributions of each component, we further conducted an ablation study. To answer Q4, we analyzed malware samples provided in the ATT&CK APT29 description to examine MAMBA's capabilities. Finally, one case study is presented to show that MAMBA locates the API calls and manipulated resources associated with the predicted TTPs to answer Q5.

Here regarding to data collection, we describe the collection of samples and labels used in the evaluations. The MITRE ATT&CK framework (version 7) for Windows includes 12 tactics, 148 techniques, 214 sub-techniques, and 378 pieces of software. We gathered malware samples and their corresponding TTPs presented in ATT&CK as the ground truth. (Note the association is called ATT&CK labeling.) For every Software page, we visited each of its elements and the TTPs mentioned by the elements. For each TTP the malicious activity is described by one or more referenced documents. We accessed these documents and used regular expressions to crawl and extract the MD5, SHA1 and SHA256 hashes of the associated malware samples. To validate the extracted hashes, we uploaded the hashes to VirusTotal [21] for verification. If a reference document had more than one malware sample, we discarded it to eliminate ambiguity. We also discarded inaccessible references such as those with anti-crawler prevention, machine-unreadable content, and broken links. A total of 2,335 malware samples (referred to as the ATT&CK dataset) were collected corresponding to 67 techniques. We also collected 23,655 malware samples from MalShare [20] verified as malware by VirusTotal [21] from January 2018 to April 2019. The combination of the ATT&CK and MalShare datasets is called the Big dataset. The statistics of the two datasets are shown in Table 2 as shown in FIG. 9. For instance, the average number of processes per malware is 3.82, and the average API calls and resources per process are 2,023.47 and 329.55 respectively, for the ATT&CK dataset.

We considered two rule-based label methods: Cuckoo Signatures (Version 2.0.7), which recognizes 43 TTPs, and RegExp, a regular expression set generated based on the TTP descriptions in ATT&CK which recognizes 169 TTPs. To label each malware sample, we applied these label methods to both the ATT&CK and Big datasets. We randomly divided the datasets into a training set (80%), a development set (10%), and a testing set (10%), We continued the above process until the F-test on the TTP distributions of the three sets showed no significant differences.

With regard to implementation settings, we used Cuckoo Sandbox [13] to obtain execution traces of malware samples. In the MAMBA implementation, the PV-DM model for resource embedding used the Gensim library [22] to produce a 100-dimension embedding vector as eᵣ. For the PV-DM model parameters, the minimum frequency threshold for each resource token was set to 5, and the size of the context window was 2. For training both resource-technique binding and the MAMBA neural network, we used the loss function with cross entropy and the Adam optimizer to update the parameters, with an initial learning rate of 0.01.

The size of binding embedding zᵣ was set to 50. The identity function was used for the σ function in (2). The weight matrix Wz was for the two layers dense networks, set to R^{100×100} and R^{100×50}. We set each API call and GRU hidden state size to 400 and 100 respectively, and set the maximum timestamp t to 500. For category and API name embedding, the weight matrices W_{c} and Wₙ were R^{100×7} and R^{100×36}. Both of the weight matrices Wᵥ and W_{d} were the two layers dense networks: Wᵥ₁ and Wᵥ₂ were set to R^{150×64} and R^{64×1}, and W_{d1} and W_{d2} were R^{150×64} and R^{64×|y|}.

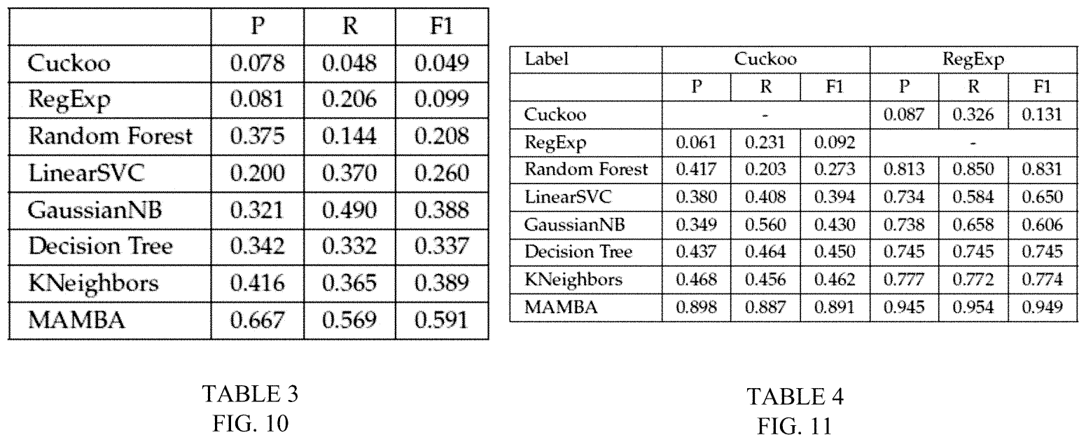

In the evaluations, we compare the performance of MAMBA and other methods using the ATT&CK and Big datasets to answer Q1 and Q2. Tables 3 and 4 as shown in FIGS. 10 and 11 compare the performance of MAMBA with two rule-based systems (Cuckoo Signatures and RegExp) and five traditional machine learning methods, LinearSVC (Linear Support Vector Classifier), Random Forest, Decision Tree, GaussianNB (Gaussian Naive Bayes), and KNeighbors (K-nearest Neighbors) in Scikit-learn [23]. As traditional machine learning methods could not accept a complete execution trace as input, we took the first five hundred API calls (with API categories and API function names only) of an execution trace and used PCA (principle component analysis) [24] to reduce the dimensions of the execution trace. For the traditional machine learning methods, the reduced API call sequences and associated TTPs were used as input. Table 3 as shown in FIG. 10 uses the ATT&CK dataset with ATT&CK labeling as the ground truth. Both Cuckoo Signatures and RegExp perform poorly as the TTPs that they recognize cover only part of ATT&CK labels on the ATT&CK dataset. The five traditional machine learning methods perform slightly better as they can learn the relationship between API calls and TTPs. With the resource attention and group attention, as well as the ATT&CK knowledge and resource embeddings, MAMBA yields the best performance of all.

To demonstrate the capabilities of MAMBA, we conducted evaluations on the Big dataset. Due to the lack of MalShare labels, the samples in the Big dataset were labeled using Cuckoo Signatures and RegExp separately, and used as the ground truth in the following evaluations. As shown in Table 4 shown in FIG. 11, when using these two labeling methods, MAMBA achieves around 90% in terms of precision, recall, and F1 score, the best performance of all the methods. This indicates that given a sufficient number of sample-TTP pairs, MAMBA successfully identifies the TTPs. In addition, the relative performance of the two rule-based methods (Cuckoo and RegExp) is poor due to their inconsistent labeling with each other.

From Table 3 as shown in FIG. 10, MAMBA achieves the best with precision, recall, and F1 at 0.667, 0.569, and 0.591 respectively, To answer Q1, the result shows the ATT&CK labeling and dataset is capable to provide useful knowledge to extract TTPs from execution traces, but due to the limited number of malware samples and TTP labels, the performance is moderate. For the question Q2, we conclude that: 1) MAMBA accurately identifies TTPs compared to rule-based and other learning-based approaches on both labeling methods from Table 4 as shown in FIG. 11. 2) Comparing to the results from Table 3 as shown in FIG. 10 and Table 4 as shown in FIG. 11, given sufficient samples and labels, MAMBA achieves high precision, recall, and F1, attesting the efficacy of the MAMBA neural network model.

With regard to ablation test, MAMBA includes knowledge from ATT&CK (binding embeddings), group dependencies (group attention), and API calls (resource attention). We conducted an ablation study to understand the contributions of each component to TTP identification using the RegExp labels on the Big dataset.

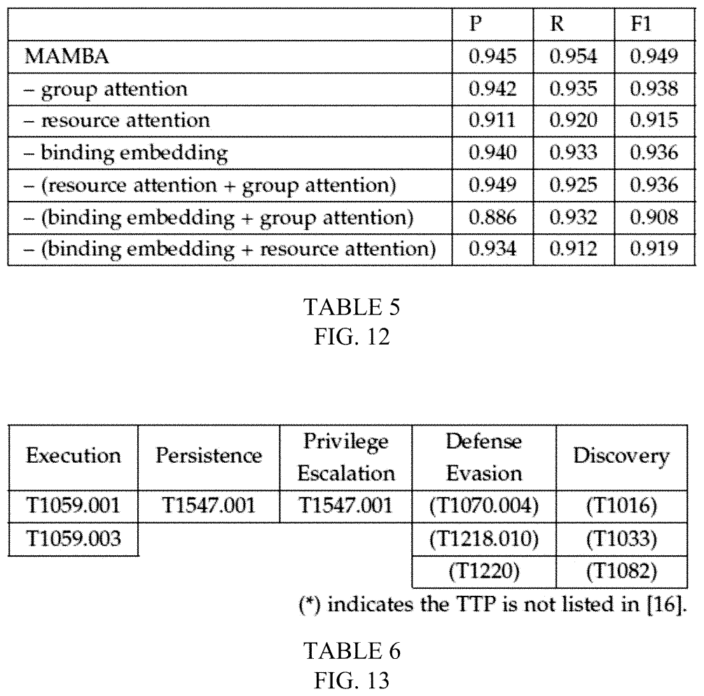

Table 5 (as shown in FIG. 12) shows that after depriving one or two components, MAMBA still perform well. All components have positive effects on F1 score, especially the resource attention, measuring the association between manipulated resources and API calls, has an obvious impact. In addition, an interesting finding is that the precision increase when only considering binding embedding, i.e. —(resource attention+group attention); one of the reasons is that it generates the fewest TTP predictions to increase precision. To answer Q3, each component of MAMBA, binding embedding, group attention and resource attention helps to discover TTPs.

The ATT&CK evaluations use known attack methods of APT groups such as APT29 [25] to evaluate cybersecurity products. In 2019, 21 security vendors participated in the evaluation using this emulated adversary environment. With this experiment we examined the capability of MAMBA trained with ATT&CK dataset and ATT&CK labeling in dealing with malware samples used in a well-known APT29 adversary, and compared the predicted TTPs with the ATT&CK APT29 Evaluation results [26]. The malware samples deployed in APT29 are well-documented in [27], [28], [29]; we collected these 310 malware samples for the evaluation and compared the outcome with those of the attending vendors.

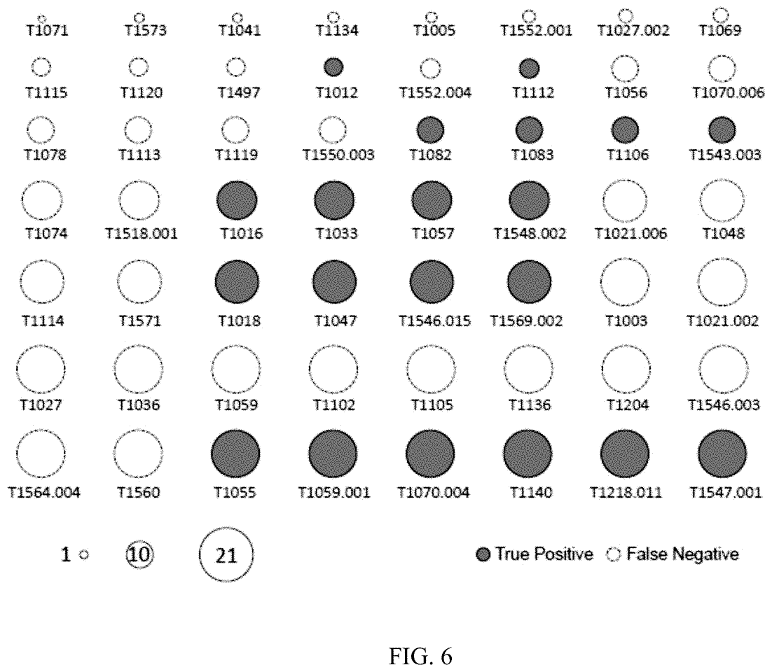

Taking 310 execution traces as inputs, MAMBA discovered 67 TTPs among 9 tactics. (As a side note, when trained with the Big dataset, MAMBA discovered 90 TTPs among 10 tactics.) Whereas 56 TTPs are listed in the APT29 Evaluations, FIG. 6 shows that 20 TTPs are recognized by MAMBA against those results from the security vendors [26]. In FIG. 6, the larger the circle is, the more vendors recognize the TTP; true positives and false negatives of MAMBA prediction are represented with different colors. In addition, MAMBA recognizes TTPs—e.g., T1056.001 Input Capture: Key logging and T1059.003 Command and Scripting Interpreter: Windows Command Shell—beyond the 56 TTPs in the ATP29 Evaluation, although the discovery of the two TTPs is consistent with [27]. However, MAMBA does produce false positive TTPs, such as T1546.010 Event Triggered Execution: AppInit DLLs, which is misidentified because MAMBA treats the registry subkey “ . . . Windows\LoadAppInit_DLLs” in an execution trace as “ . . . \AppInit_DLLs” in the MITRE webpage.

To answer Q4, MAMBA demonstrates the feasibility of capturing TTPs on malware samples used in a threat group. However, there are still some shortcomings due to the statistical characteristics of deep learning and the size limitation of ATT&CK dataset.

This part with regard to resource and API locating presents a post-processing heuristic to locate the APIs and manipulated resources of malicious behaviors, and discusses a case study that demonstrates the effectiveness of API call location.

At inference time, MAMBA predicts TTPs ŷ and locates related API calls x̅⊆x for a given execution trace x. Given the group attentions in (12) and the resource attentions in (9), we find the dominant resources for discovering TTPs and locating the related API calls in a process. More specifically, a set of manipulated resources r̅_{ŷ} is selected based on two criteria: i) the similarity between the resources documented in ATT&CK and the manipulated resources, and ii) the group attention. The similarity scores reveal the likelihood that a certain resource is being manipulated to implement a TTP. The group attention measures how much information a resource provides, that is, whether it is a common or rare resource across API calls. A large group attention value for a resource indicates that the resource is frequently used among API calls or processes; in contrast, a resource with a small group value means that it is uniquely representative, or is used only by chance. Security analysts use this to select observable resources by setting a threshold thd for the corresponding similarity scores and k as the number of highest and lowest attention values. Once the resources are selected, malicious behavior can be located via the API calls whose resource attention values are larger than the largest attention value minus a times the standard deviation. Algorithm 2 describes the location process for the alignment of API calls and resources.

Input: an execution trace x, a set of group attention v, a set of resource
attentions s, a set of predicted TTPs ŷ from a neural network in
accordance with the present application, knowledge pairs of {resource r,
TTP y} extracted from OSINT.
Output: a set of selected manipulated resource r̅_{ŷ} and its corresponding
API call subsequences x̅_{ŷj}

| | |
|---|---|
| 01: | for each TTP ŷ do |
| 02: | #Select possible resource r̅_{ŷ} for a certain TTP ŷ |
| 03: | i ← extracting resource r from knowledge pairs {r, y} when given |

TTP ŷ

| | |
|---|---|
| 04: | for each resource i do |
| 05: | for each manipulated resource j in x do |
| 06: | score(i, j) = sim(eᵢ, eⱼ) |
| 07: | end for |
| 08: | end for |
| 09: | r̅_{ŷ} ← extracting j when score(i, j) > threshold_{ŷ} |
| 10: | r̅_{ŷ} ← extracting top and bottom j of sort(v) |
| 11: | # Locate API call x̅ⱼ for a certain resource j |
| 12: | for each resource j in r̅_{ŷ} do |
| 13: | for each resource attention s in sⱼ do |
| 14: | x̅_{ŷj} ← extracting x when s ≥ max(sⱼ) − astd(sⱼ) |
| 15: | end for |
| 16: | end for |
| 17: | end for |

As there is no benchmark for a quantitative evaluation of the efficacy of associated API call location, we here present a case study on a JCry malware sample to demonstrate MAMBA's resources and its ability to align API calls. The malicious activities of JCry were presented as a motivating example. The malware sample manipulates 8,440 resource groups in seven processes. Based on the MITRE website [16], JCry is labeled with seven TTPs: T1547.001, T1059.001, T1059.003, T1059.005, T1486, T1490, and T1204.002. Nine techniques are predicted by MAMBA, among which T1547.001, T1059.001 and T1059.003 are consistent with the content on the MITRE website; T1033, T1070.004, T1082, T1016, T1218.0W, and T1220 are not listed.

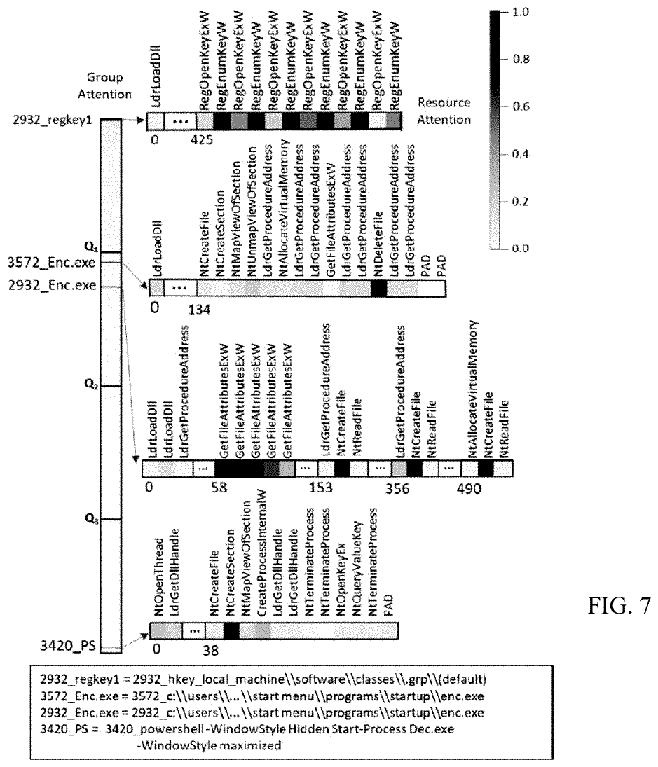

FIG. 7 shows the sorted group attentions and their associated resource attentions of selected resources found by Algorithm 2. The highest group attention refers to subkey 2392_regkey1 “HKEY_LOCAL_MACHINE\SOFTWAREClasses”, which is heavily manipulated (443 times). Its high group attention scores and high associated resource attentions lead to the discovery of TTP T1082 System information Discovery. The 2392_regkey1 subkey and its many high resource attentions, depicted as the first row of resource attention in FIG. 7, such as APIs “RegEnumKeyW” and “RegOpenKeyExW” that enumerate and attempt to open subkeys, support the discovery of the TTP The behavior meets the description of T1082; “RegEnumKeyW” and “RegOpenKeyExW” are the associated API calls.

The algorithm then finds 3572_Enc.exe, with which we find the TTP T1070.004 Indicator Removal on Host: File Deletion discovered by MAMBA but not documented on the MITRE website [16]. The group attention (3572_Enc.exe) and its highest resource attentions “NtDeleteFile” together support the discovery of TTP T1070.004. This malicious behavior can be observed in the execution trace as well: it deletes the self-created files to evade detection.

FIG. 7 depicts the discovery of TTPs T1547.001 and T1059.001, which are listed on the MITRE website. The group attention of 2932_Enc.exe is high and the resource attentions of associated API calls such as “NtCreateFile” and “GetFileAttributesExW” are also high, suggesting TJ547.001 Boot or Logon Autostart Execution: Registey Run Key/Startup Folder. The next group attention for the command line 3420_PS and its resource attentions “NtCreateSection” and “CreateProcessIntenalW” contribute to the identification of TTP TW59.001 Command and Scripting Interpreter: PowerShell.

However, MAMBA fails to recognize TTPs T1033 System Owner/User Discovery and T1218.010 Signed Binary Proxy Execution:Regsvr32, as their behaviors are not found in the Cuckoo Sandbox execution trace. TTP T1220 XSL Script Processing is also not recognized when JCry renames and encrypts XML files. Moreover, T1204.002 User Execution: Malicious File is not recognized because it involves human action. Finally, MAMBA does not recognize TTPs T 1059.005, T1486, and T1490.

Following the MITRE ATT&CK framework, Table 6 as shown in FIG. 13 presents the life cycle of the associated TTPs of the JCry analysis, indicating correspondences between the discovered TTPs and TTPs listed in [16].

To answer Q5, the group and resource attention mechanisms indeed capture the relations among the predicted TTPs, the manipulated resources, and the corresponding API calls; some mistakes are made because they are not found in the execution trace, some require human interaction, and some are not explainable.

In MAMBA, the proposed system, the key drivers to discovering MITRE techniques include 1) incorporating knowledge from the MITRE ATT&CK framework, 2) considering the relation between resources and API calls, and 3) leveraging resource dependencies among processes. Based on these drivers, the design of the MAMBA neural network includes 1) binding embeddings, 2) resource attention, and 3) group attention. These ensure that MAMBA achieves the best performance on both ATT&CK and Big datasets. In addition, this study demonstrates a usage of the MITRE ATT&CK framework in cybersecurity applications in general that increases the interpretability of the deep learning outcomes.

The information collected from ATT&CK has limitations, as the data collection process of MITRE ATT&CK framework relies heavily on contributions from security experts and organizations; as a result the data may be neither timely nor complete. This limits the capability of cybersecurity systems that rely solely on the MITRE ATT&CK framework as knowledge source. In this case, performance can be improved if the system adopts more OSINTs and other reliable sources. In this work, we focus on Windows malware and its associated TTPs, but the concept of our approach is not limited to a certain operating system such as Microsoft Windows since malicious behaviors could be discovered by aligning the manipulated resources to the knowledge of ATT&CK.

The applicant believes that this present application is the first attempt to leverage the knowledge collected from OSINTs in deep learning analysis of malicious behavior. All references recited in this application can be found in the corresponding provisional patent application.

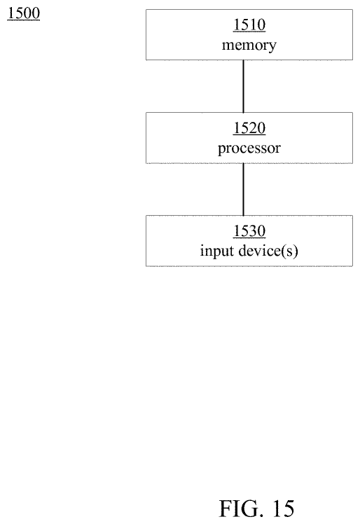

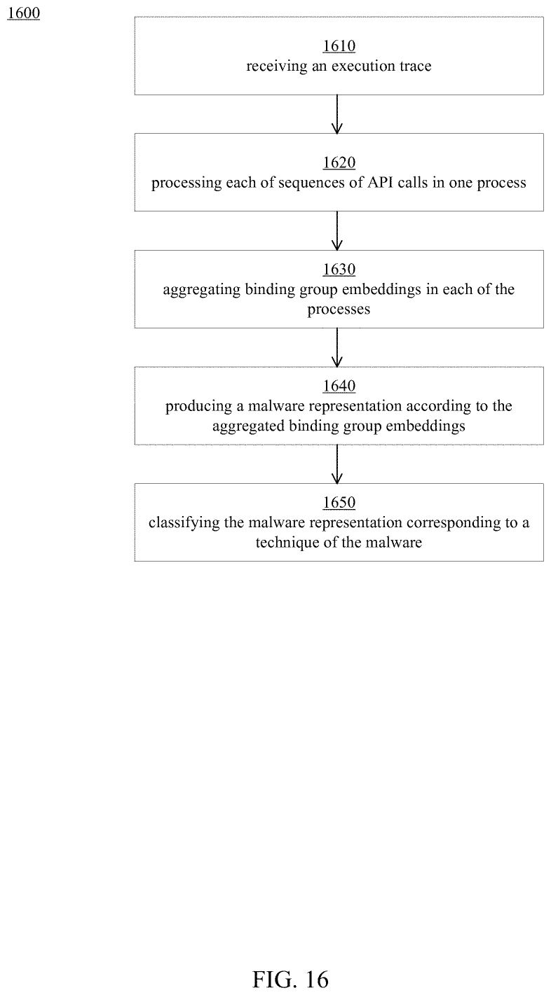

Please refer to FIG. 15, which depicts a computer 1500 in accordance with an embodiment of the present application. The computer 1500 comprises a memory 1510, at least one processor 1520 and one or more input devices 1530 such as keyboard, mouse, networking devices for receiving information. The memory 1510 is configured for storing instructions being executed by the processor 1520 and data corresponding to the instructions. The processor 1520 is able to execute the instructions to realize the embodiments provided by the present application. For examples, the method 1600 as shown in FIG. 16 may be realized by the computer 1500.

Please refer to FIG. 16, which depicts a method 1600 in accordance with an embodiment of the present application. The method 1600 is configured for learning a correspondence between malware behaviors and an execution trace of the malware by training a neural network model or MAMBA. Person having ordinary skill in the art can understand and realize backward propagation steps to adjust trainable weights of the neural network. The training of the neural network model is done until the neural network is convergent. Implementing one instance of forward propagation of a neural network, the method 1600 comprises following steps.

Step 1610: receiving an execution trace which includes one or more sequences of application programming interface (API) calls, wherein each of the API calls is corresponding to one or more resources of a computer system and operated by the malware.

Step 1620: processing each sequence of the API calls in a process, respectively, for generating a binding group embedding for each of the resources corresponding to the API calls in each of the process. In one embodiment, the binding group embedding for one of the resources is generated according to a binding embedding and a group vector corresponding to the one of the resources. In one embodiment, the binding embedding corresponding to the one of the resources is derived from a resource-technique neural network which is trained according to correlation pairs of techniques and resources denoted in a database. In one embodiment, the group vector corresponding to the one of the resources is a weighted average of hidden states of the resources corresponding to the API call. In one embodiment, weights of the weighted average of hidden states are resource attention weights of the one of the resources in a process and the resources corresponding to the API call. In one embodiment, the resource attention weights are normalized according to a distribution of the resources corresponding to the API call. In one embodiment, the hidden states of the resources corresponding to the API call are provided by a recurrent neural network which operates on API call embeddings corresponding to the API calls of the execution trace. In one embodiment, the recurrent neural network uses gated recurrent units. In one embodiment, each of the API call embeddings is a concatenation of an embedding of a category, an embedding of an API name, and one or more resource embeddings corresponding to the resources corresponding to the API call. In one embodiment, at most three of the resource embeddings corresponding to each of the API embeddings are in the concatenation. In one embodiment, the resource embeddings are transformed by a paragraph vector distributed method. In one embodiment, the resource-technique neural network is a multiple layered perceptron (MLP) network. In one embodiment, the resource embeddings are transformed by a paragraph vector distributed method.

Step 1630: aggregating the binding group embeddings in each of the processes.

Step 1640: producing a malware representation according to the aggregated binding group embeddings. In one embodiment, the malware representation is produced further according to group attentions scores of the binding group embeddings in each of the processes.

Step 1650: classifying the malware representation corresponding to one or more techniques implemented by the malware. In one embodiment, the classifying uses a sigmoid function of the malware representation.

In some embodiments, the steps recited in the embodiments may be implemented in a form of instructions which are executable by processors and data stored in a non-transitory memory, a non-volatile memory or a computer readable medium. In addition, the present application does not limit execution order of any two steps unless they are causal. Steps of the exemplary methods may be implemented by software, hardware or any combination of software and hardware. Specified computer hardware may be used to implement some steps such as matrix multiplications or vector manipulations. An application programmable interface is a sort of a computing interface that defines multiple software applications or mixed hardware-software intermediates. Examples of APIs include APIs for programmable languages, software libraries, computer operating systems, and computer hardware. The resource denoted in the embodiments may refer to a part or a full of arguments of API, data used by API or inputs of API.

In some embodiments, the source may be an open-source intelligence database or framework such as MITRE ATT&CK. The so-called open-source intelligence database or framework may be public and open. The present application does not limit the open-source intelligence database is totally free of charge. Access privilege of the open-source intelligence database may be granted to anyone if proper fee is paid for maintaining and sustaining operations of the open-source intelligence database.

According to an embodiment, it provides a computer for implementing a neural network in order to detect one or more malicious behaviors according to samples of execution trace of the malicious behaviors, each of the samples of execution traces is corresponding to one process, each of the processes comprises one or more API (application programmable interface) calls, each API call has none, one or more resources, wherein the computer comprising one or more processors configured to implement following steps until trainable weights of the neural network are convergent: forward propagation steps, comprising: for each of the processes of each of the samples of execution traces, comprising: generating API call embeddings according to the API calls in instant one of the processes; deriving a hidden vector according to ordinal information of the API call embeddings for each of the API call embeddings; for each one of resource embeddings in each of the processes, wherein the resource embeddings are generated by a paragraph vector distributed memory method; for each resource attention score according to instant one of the resource embeddings in a process and the resource embedding from the corresponding API call; computing resource-based API call group vectors according to the resource attention scores and their corresponding hidden vectors; and generating a binding group embedding according to the resource-based API call group vectors and binding embeddings, wherein the binding embeddings are derived from a resource-technique neural network which is trained according to correlation pairs of techniques and resources denoted in a database; calculating group attention scores corresponding to the processes of instant one of the samples of execution trace according to a self-attention mechanism of all the binding group embeddings; calculating a malware embedding according to the group attention scores and the binding group embeddings; and calculating a probability of each of the malicious behaviors according to the malware embedding; and backward propagation steps for updating the trainable weights.

Preferably, in order to utilize collective knowledge in public domain, the database is an open-source intelligence database.

Preferably, in order to classify the resources used by the malwares, the resources are categorized into at least one of following types: file, library, registry, process and network.

Preferably, in order to embed the resources into the neural network, the resource embeddings are n-dimensional real-valued vectors generated, where n is a natural number. Preferably, the generation of the resource embeddings is done by applying a paragraph vector distributed memory method to the extracted resources.

Preferably, in order to embed the resources into the neural network, the binding embeddings n-dimensional real-valued vectors generated according to correlation pairs of techniques and resources denoted in a database, where n is a natural number.

Preferably, in order to preserve ordinal information, the hidden vectors are derived by a recurrent neural network.

Preferably, in order to find the connection between each pair of API calls and manipulated resource in a process, each of the resource attention scores is related to a maximum of one of normalized correlations corresponding to the resources of the API call embeddings and the resources embeddings in the instant one of the processes.

Preferably, in order to utilize collective knowledge in public domain, wherein one of the malicious behaviors is defined as one of tactics, techniques and procedures (TTPs) found in an open-source intelligence database.

Preferably, in order to inference the trained neural network, the one or more processors are further configured to execute instructions for: applying an execution trace to the trained neural network; and determining whether each of the malicious behaviors is included in the execution trace according to the probabilities corresponding to each of the malicious behaviors outputted by the trained neural network, respectively.

According to an embodiment of the present application, it provides a method for implementing a neural network in order to detect one or more malicious behaviors according to samples of execution trace of the malicious behaviors, each of the samples of execution traces is corresponding to one process, each of the processes comprises one or more API (application programmable interface) calls, each API call has none, one or more resources, wherein the method comprising following steps until trainable weights of the neural network are convergent: forward propagation steps, comprising: for each of the processes of each of the samples of execution traces, comprising: generating API call embeddings according to the API calls in instant one of the processes; deriving a hidden vector according to ordinal information of the API call embeddings for each of the API call embeddings; for each one of resource embeddings in each of the processes, wherein the resource embeddings are generated by a paragraph vector distributed memory method; for each resource attention score according to instant one of the resource embeddings in a process and the resource embedding from the corresponding API call; computing resource-based API call group vectors according to the resource attention scores and their corresponding hidden vectors; and generating a binding group embedding according to the resource-based API call group vectors and binding embeddings, wherein the binding embeddings are based on the resources in the API calls; calculating group attention scores corresponding to the processes of instant one of the samples of execution trace according to a self-attention mechanism of all the binding group embeddings; calculating a malware embedding according to the group attention scores and the binding group embeddings; and calculating a probability of each of the malicious behaviors according to the malware embedding; and backward propagation steps for updating the trainable weights.

Preferably, the provided method is implemented by the one or more processors of the aforementioned computer with the provided features or limitations.

According to an embodiment of the present application, it provides a method for learning a correspondence between malware behaviors and an execution trace of the malware, comprising: receiving an execution trace which includes one or more sequences of application programming interface (API) calls, wherein each of the API calls is corresponding to one or more resources of a computer system and operated by the malware; processing each sequence of the API calls in a process, respectively, for generating a binding group embedding for each of the resources corresponding to the API calls in each of the process; aggregating the binding group embeddings in each of the processes; producing a malware representation according to the aggregated binding group embeddings; and classifying the malware representation corresponding to a technique of the malware.

Preferably, in order to correlate resources used in the API calls in a sequence, the binding group embedding for one of the resources is generated according to a binding embedding and a group vector corresponding to the one of the resources.

Preferably, in order to take advantage of knowledge regarding to connections of techniques and resource denoted in a database, the binding embedding corresponding to the one of the resources is derived from a resource-technique neural network which is trained according to correlation pairs of techniques and resources denoted in a database.

Preferably, in order to concern about the connections between an API call and its corresponding resources in a process, the group vector corresponding to the one of the resources is a weighted average of hidden states of the resources corresponding to the API call.

Preferably, weights of the weighted average of hidden states are resource attention weights of the one of the resources in a process and the resources corresponding to the API call.

Preferably, the resource attention weights are normalized according to a distribution of the resources corresponding to the API call.

Preferably, in order to preserve ordinal information of API calls in a process, the hidden states of the resources corresponding to the API call are provided by a recurrent neural network which operates on API embeddings corresponding to the API calls of the execution trace.

Preferably, in order to utilize API call information in the neural network, each of the API call embeddings is a concatenation of an embedding of a category, an embedding of an API name, and one or more resource embeddings corresponding to the resources corresponding to the API call.

Preferably, the category includes at least one of following types: file, library, registry, process and network.

Preferably, in order to provide correlation likelihood of resources and techniques learned from the database, the resource-technique neural network is a multiple layered perceptron (MLP) network.

Preferably, each of the correlation pairs includes resource embeddings of the resources denoted in the database, the resource embeddings are transformed by a paragraph vector distributed method.

Preferably, in order to reflect that the resources may be manipulated among processes, the malware representation is produced further according to group attentions scores of the binding group embeddings in each of the processes.

Preferably, in order to provide independent classification in a multi-label problem of techniques, the classifying uses a sigmoid function of the malware representation.

Preferably, in order to adapt knowledge of public domain, the database is ATT&CK.

According to an embodiment of the present application, it provides a computer for learning a correspondence between malware behaviors and an execution trace of the malware, comprising: a non-volatile memory for storing instructions and data corresponding to the instructions; and a processor configured to execute the instructions for: receiving an execution trace which includes one or more sequences of application programming interface (API) calls, wherein each of the API calls is corresponding to one or more resources of a computer system; processing each sequence of the API calls in a process, respectively, for generating a binding group embedding for each of the resources corresponding to the API calls in each of the process; aggregating the binding group embeddings in each of the processes; producing a malware representation according to the aggregated binding group embeddings; and classifying the malware representation corresponding to a technique of the malware.

Preferably, what the processor executes is met with the aforementioned features and limitations corresponding to the method.

While the invention has been described in terms of what is presently considered to be the most practical and preferred embodiments, it is to be understood that the invention needs not to be limited to the above embodiments. On the contrary, it is intended to cover various modifications and similar arrangements included within the spirit and scope of the appended claims which are to be accorded with the broadest interpretation so as to encompass all such modifications and similar structures.

What is claimed is:

1. A method for learning a correspondence between malware behaviors and an execution trace of the malware, comprising:
receiving an execution trace which includes one or more sequences of application programming interface (API) calls, wherein each of the API calls is corresponding to one or more resources of a computer system and operated by the malware;
processing each sequence of the API calls in a process, respectively, for generating a binding group embedding for each of the resources corresponding to the API calls in each of the process;
aggregating the binding group embeddings in each of the processes;
producing a malware representation according to the aggregated binding group embeddings; and
classifying the malware representation corresponding to a technique of the malware.

2. The method of claim 1, wherein the binding group embedding for one of the resources is generated according to a binding embedding and a group vector corresponding to the one of the resources.

3. The method of claim 2, wherein the binding embedding corresponding to the one of the resources is derived from a resource-technique neural network which is trained according to correlation pairs of techniques and resources denoted in a database.

4. The method of claim 2, wherein the group vector corresponding to the one of the resources is a weighted average of hidden states of the resources corresponding to the API call.

5. The method of claim 4, wherein weights of the weighted average of hidden states are resource attention weights of the one of the resources and the resources corresponding to the API call.

6. The method of claim 5, wherein the resource attention weights are normalized according to a distribution of the resources corresponding to the API call.

7. The method of claim 4, wherein the hidden states of the resources corresponding to the API call are provided by a recurrent neural network which operates on API call embeddings corresponding to the API calls of the execution trace.

8. The method of claim 7, wherein each of the API call embeddings is a concatenation of an embedding of a category, an embedding of an API name, and one or more resource embeddings corresponding to the resources corresponding to the API call.

9. The method of claim 8, wherein the category includes at least one of following types: file, library, registry, process and network.

10. The method of claim 8, wherein the resource embeddings are transformed by a paragraph vector distributed method.

11. The method of claim 3, wherein the resource-technique neural network is a multiple layered perceptron (MLP) network.

12. The method of claim 3, wherein each of the correlation pairs includes resource embeddings of the resources denoted in the database, wherein the resource embeddings are transformed by a paragraph vector distributed method.

13. The method of claim 1, wherein the malware representation is produced further according to group attentions scores of the binding group embeddings in each of the processes.

14. The method of claim 1, wherein the classifying uses a sigmoid function of the malware representation.

15. The method of claim 3, wherein the database is ATT&CK.

16. A computer for learning a correspondence between malware behaviors and an execution trace of the malware, comprising:
a non-volatile memory for storing instructions and data corresponding to the instructions; and
a processor configured to execute the instructions for:
receiving an execution trace which includes one or more sequences of application programming interface (API) calls, wherein each of the API calls is corresponding to one or more resources of a computer system and operated by the malware;
processing each sequence of the API calls in a process, respectively, for generating a binding group embedding for each of the resources corresponding to the API calls in each of the process;
aggregating the binding group embeddings in each of the processes;
producing a malware representation according to the aggregated binding group embeddings; and
classifying the malware representation corresponding to a technique of the malware.

17. The computer of claim 16, wherein the binding group embedding for one of the resources is generated according to a binding embedding and a group vector corresponding to the one of the resources.

18. The computer of claim 17, wherein the binding embedding corresponding to the one of the resources is derived from a resource-technique neural network which is trained according to correlation pairs of techniques and resources denoted in a database.

19. The computer of claim 17, wherein the group vector corresponding to the one of the resources is a weighted average of hidden states of the resources corresponding to the API call.

20. The computer of claim 19, wherein weights of the weighted average of hidden states are resource attention weights of the one of the resources and the resources corresponding to the API call.

21. The computer of claim 20, wherein the resource attention weights are normalized according to a distribution of the resources corresponding to the API call.

22. The computer of claim 19, wherein the hidden states of the resources corresponding to the API call are provided by a recurrent neural network which operates on API call embeddings corresponding to the API calls of the execution trace.

23. The computer of claim 22, wherein each of the API call embeddings is a concatenation of an embedding of a category, an embedding of an API name, and one or more resource embeddings corresponding to the resources corresponding to the API call.

24. The computer of claim 23, wherein the category includes at least one of following types: file, library, registry, process and network.

25. The computer of claim 23, wherein the resource embeddings are transformed by a paragraph vector distributed method.

26. The computer of claim 18, wherein the resource-technique neural network is a multiple layered perceptron (MLP) network.

27. The computer of claim 18, wherein each of the correlation pairs includes resource embeddings of the resources denoted in the database, wherein the resource embeddings are transformed by a paragraph vector distributed method.

28. The computer of claim 16, wherein the malware representation is produced further according to group attentions scores of the binding group embeddings in each of the processes.

29. The computer of claim 16, wherein the classifying uses a sigmoid function of the malware representation.

30. The computer of claim 18, wherein the database is ATT&CK.

31. A method for implementing a neural network in order to detect one or more malicious behaviors according to samples of execution trace of the malicious behaviors, each of the samples of execution traces is corresponding to one process, each of the processes comprises one or more API (application programmable interface) calls, each API call has none, one or more resources, wherein the method comprising following steps until trainable weights of the neural network are convergent:
forward propagation steps, comprising:
for each of the processes of each of the samples of execution traces, comprising:
generating API call embeddings according to the API calls in instant one of the processes;
deriving a hidden vector according to ordinal information of the API call embeddings for each of the API call embeddings;
for each one of resource embeddings in each of the processes, wherein the resource embeddings are generated by a paragraph vector distributed memory method;
calculating resource attention scores according to instant one of the resource embeddings in one of the processes and the resource embedding from the corresponding API call;
computing resource-based API call group vectors according to the resource attention scores and their corresponding hidden vectors; and
generating a binding group embedding according to the resource-based API call group vectors and binding embeddings, wherein the binding embeddings are based on the resources in the API calls;
calculating group attention scores corresponding to the processes of instant one of the samples of execution trace according to a self-attention mechanism of all the binding group embeddings;
calculating a malware embedding according to the group attention scores and the binding group embeddings; and
calculating a probability of each of the malicious behaviors according to the malware embedding; and
backward propagation steps for updating the trainable weights.
